(19) United States
(12) Patent Application Publication
(10) Pub. No.: US 2012/0303764 A1
(43) Pub. Date: Nov. 29, 2012

(54) PEER-TO-PEER SYSTEM WITH CENSORSHIP

(75) Inventors: Nicolas Waldorff Hyltoft Ibenforth, Helsingor (DK); Martin Østergaard, Aabybro (DK); Ahmed Ovais Akhter, Soborg (DK)

(73) Assignee: EOVENDO APS, Brabrand (DK)

(21) Appl. No.: 13/515,604

(22) PCT Filed: Dec. 18, 2009
(86) PCT No.: PCT/DK2009/050346

§ 371 Date: Aug. 10, 2012

(51) Int. Cl. G06F 15/16

(52) U.S. Cl. 709/219

(57) ABSTRACT

The present invention relates to a system and a method for publishing a media file and for distributing a media file to a requester over a communication network. The system comprises a plurality of servers and allows media file distribution that respects censorship rules bound to geographical distinct territories and countries also taking into account quality of service of the media distribution.

### FIELD OF THE INVENTION

Generally, the present invention lies within the field of communication technology, in particular within the field of media content distribution. Specifically, the invention provides a system for publishing and distributing a media file to a client over a communication network.

### BACKGROUND OF THE INVENTION

WO 2008/038280 A1 discloses a method and system for real-time streaming over a peer-to-peer (grid) network. The system is capable of controlling the peers in the network, guaranteeing the overall channel quality, and guaranteeing a secure media delivery over a packet-based network. According to an aspect of the method, the method comprises the steps of selecting the peers to be assigned to the user-peer further comprising: for each peer in the peer-to-peer network: computing a historical value using the historical information; computing a topologic value using the topological information; computing a dynamic value using the dynamic information; computing a peer value using the historical value, the topologic value, and the dynamic value; and selecting the peers having higher peer values to be assigned to the user-peer. The method and the system do not take into account the content of the files sent in the peer-to-peer network.

US 2007/0028133 relates to improvement of the Bit Torrent protocol, which is one of the P2P protocols. A seeder flag is added to the active peer table. First a super seeder having the original is activated, and the super seeder is stopped when the total value of the seeder flags (number of activated seeders) reaches a certain level. The super seeders are activated only when the seeders having the original of a file are insufficient on the network, and are stopped when excessive. By this dynamic control, the number of activated processes of the super seeders can be decreased. Files are transferred relaying packets from the server having the original file called a “super seeder” as a start. Each server, which is called the leecher, distributes a portion, received as a piece seeder from the received portion, to other peers. A client having received at least a part of the file plays a role to distribute this portion. The method and the system do not take into account the content of the files sent in the P2P network.

Hence, an improved method and system in a peer-to-peer (P2P) network would be advantageous, and in particular a more efficient and/or reliable file distribution between peers, i.e., seeders, lechers and other clients, would be advantageous.

### OBJECT OF THE INVENTION

In particular, it may be seen as an object of the present invention to provide a system of a peer-to-peer network that solves the above mentioned problems of the prior art that distributes files without taking into account the content of the files sent between seeders, lechers and other clients.

### SUMMARY OF THE INVENTION

Thus, the above described object and several other objects are intended to be obtained in a first aspect of the invention by providing a system with
a) at least one application server adapted to
   i) receive the media file,
   ii) examine the media file to determine a content of the media file,
   iii) send the media file, and
   iv) send a peer-to-peer file corresponding to the media file,
b) at least one conversion server adapted to
   i) receive the media file,
   ii) convert the media file into the peer-to-peer file, and
   iii) send the peer-to-peer file,
c) at least one distribution server adapted to
   i) receive the peer-to-peer file;
d) said system adapted to:
   i) select, based on a plurality of criteria, said at least one distribution server where the peer-to-peer file is to be indexed, said criteria being at least a criteria within the following categories: a content of the media file, a geographic location of a recipient of the peer-to-peer file, a set of law of the geographic location, a load balancing;
   ii) send, to the selected distribution server, the peer-to-peer file for the peer-to-peer file to be indexed at the selected distribution server.

The invention is particularly, but not exclusively, advantageous for obtaining a reliable system for legally and morally correct providing, downloading and displaying advertisements and other media files based on specific criteria, preferably a criteria being the a geographical location of a receiver of at least a fragment of at least one media file.

Thereby, the invention provides a censorship of media files distributed in a peer-to-peer system. As mentioned, censorship is preferably based on the geographical location of the receiver of at least a fragment of a at least one media file, but may also based on a set of law of the geographic location and/or a load balancing. According to an aspect of the invention
a tracking server is adapted to provide a list of at least one location information of at least the fragment of the peer-to-peer file at the at least one seeder or at the at least one distribution server, based on at least one of the following criteria:
availability, at the at least one seeder computing device, of at least the fragment of the peer-to-peer file corresponding to the identifier,
a content of the media file, a geographic location of a recipient of the peer-to-peer file, or a set of law of the geographic location,
the requester adapted to select at least one seeder to be requested among the plurality of the at least one seeder, based on at least one criteria characterizing a quality of a communication link between the requester and the at least one seeder.

The censorship according to the invention of the peer-to-peer system may alternatively or additionally be based on a criteria characterizing a quality of a communication link between the requester and the at least one seeder. Thereby, not only one or more criteria of geographical location, set of laws and load balancing determs the distribution of at least a fragment of at least one media file, but also criteria of communication link quality is or may be a determining factor.

The invention also relates to an apparatus of a requester, said apparatus having computing capabilities and having connectivity to a communication network, said apparatus adapted to: a) send, to a seeder, a request for a media file over the communication network, b) send, to a seeder, a request for a peer-to-peer file associated with the requested media file, c) receive a response, the response being related to the peer-to-peer file associated with the requested media file.

Associating a media file with a peer-to-peer file enables censorship in relation to a requester of the media file in a peer-to-peer communication network.

The invention also relates to an apparatus of a seeder, said apparatus having computing capabilities and having connectivity to a communication network, said apparatus adapted to: a) receive, from a requester, a request for at least a fragment of a peer-to-peer file, b) send, to the requester, at least the fragment of the peer-to-peer file requested.

Associating a media file with a peer-to-peer file enables censorship in relation to a seeder of the media file in a peer-to-peer communication network.

The invention also relates to a method for publishing a media file, the method comprising:
a) sending the media file over the communication network from a client computing device of a content provider;
b) receiving the media file at an application server of a publishing system;
c) examining in the publishing system the media file to determine a content of the media file,
d) converting in the publishing system the media file into a peer-to-peer file,
e) selecting a distribution server in the publishing system where the peer-to-peer file is to be indexed, based on a plurality of criteria, said plurality of criteria comprising at least a criteria within the following categories: a content of the media file, a geographic location of a recipient of the peer-to-peer file, a set of law of the geographic location, or a load balancing;
f) sending to the selected distribution server the peer-to-peer file for indexing the peer-to-peer file at the selected distribution server.

The method according to the invention, similarly to the system according to the invention, is particularly, but not exclusively, advantageous for obtaining a reliable method for legally and morally correct providing, downloading and displaying advertisements and other media files based on criteria, preferably a criteria being the a geographical location of a receiver of at least a fragment of at least one media file.

According to a possible embodiment of the system according to the invention and a possible aspect of the method according to the invention, the application server is adapted to initially authenticate a client having sent a request to the application server, and wherein the application server is adapted to subsequently send an identifier associated with the peer-to-peer file to the client, provided the client initially has been authenticated by the application server.

In an aspect, the invention relates to a computer program product being adapted to enable a computer system comprising at least one computer having data storage means in connection therewith to control a computer.

According to a specific embodiment of the present invention, it may be combined with a system for advertising based on user-relevant categories of advertisements.

Said system for advertising based on user-relevant categories of advertisements, and which the system of the present invention may be combined with, comprises a client computing device having electronic communication network connectivity and at least one display for visual output from the computing device, a browser constituting part of said system and adapted to run on said client computing device for accessing content on a communication network, an advertising software constituting part of said system and adapted to run on said client computing device for accessing advertisements, said advertising software comprising means for obtaining information about user-relevant categories of advertisements, said advertising software comprising means for downloading multimedia files comprising image advertisements in accordance with said user-relevant categories, said advertising software being adapted to display at least one of said multimedia files as image advertisements on the display, wherein said advertising software furthermore comprises means for detecting a triggering event initiated by the user activating a user input interface of the client computing device, said advertising software allowing the user to choose whether or not to display at least one of the image advertisements downloaded, upon detection of the triggering event, and with the proviso that the user, after having been allowed to choose, has chosen to display at least at least one of the image advertisements downloaded, said advertising software being adapted to at least temporarily block access to content on a communication network as long as it is displaying said at least one multimedia file.

A system allowing the user to choose whether or not to display at least one image advertisement downloaded may have the effect that the advertiser is certain that the user is offered the possibility of watching advertisements while at the same time the user still has control at any time over what the computing device displays among different image advertisements downloaded at the computing device.

Combined with the system for targeted advertisement, said system comprises a client computing device having Internet connectivity and at least one display screen, a browser software adapted to run on said client computing device for accessing World Wide Web content, an advertising software adapted to run on said client computing device, said advertising software allowing the user to indicate preferred categories of advertisements, said advertising software comprising means for downloading multimedia files comprising image advertisements in according with said preferred categories, said advertising software being adapted to display said multimedia files as image advertisements on the screen, wherein said advertising software is adapted to at least temporarily block access to World Wide Web content as long as it is running. The image advertisements may be still image or moving image advertisements or a combination of both images. Subsequently to displaying the multimedia files, the user is then automatically directed to the World Wide Web.

According to an aspect of the combined systems, said advertising software is adapted to block access for said computing device to said browser. Thereby, the user is prompted to choose to display the advertisement on the computing device.

According to another aspect of the combined systems, said triggering event is a start of said browser on the computing device. The triggering event for at least allowing the user whether to display the advertisement or not may result in the advertisements often being displayed, considering that starting a browser on a computing device is an event that happens often on a computing device.

According to another aspect of the combined systems, said triggering event is a start of said advertising software on the computing device. If one choice of the user is to start running the advertisement software, the result is that at least one advertisement will be displayed on the computing device.

According to another aspect of the combined systems, said advertising software is allowing the user to choose to display at least one of the image advertisements downloaded amongst advertisements most recently downloaded, upon detection of the triggering event. The choice resulting in different possibilities of viewing advertisements may result in the advertisements often being displayed, considering that the user may choose among different advertisements being grouped based on different characteristics of the advertisements.

According to another aspect of the combined systems, said advertising software is allowing the user to choose to display at least one of the image advertisements downloaded amongst the advertisements being rated as the best by a plurality of users, upon detection of the triggering event. If one choice of the user is to start running the advertisement software for displaying at least one advertisement being characterized as the best, the result is that at least one advertisement will be displayed on the computing device.

According to another aspect of the combined systems, said advertising software is allowing the user to choose to display at least one of the image advertisements downloaded amongst the advertisements the most viewed by a plurality of users, upon detection of the triggering event. If one choice of the user is to start running the advertisement software for displaying at least one advertisement being characterized as the most viewed, the result is that at least one advertisement will be displayed on the computing device.

According to an aspect of the combined systems, said advertising software is adapted to upload the downloaded multimedia files to other client computing devices. Uploading multimedia files from other client computing devices may result in a faster and/or a safer and/or an easier and/or a better access to multimedia files than from a centralized server.

According to an aspect of the combined systems, said software comprises means for registering information about the upload of multimedia files, means for communicating said information to a server, said server comprising means for effecting remuneration of a person identified as the user of the software. Remuneration of the user of the software may result in user being more prone to choosing to display one or more advertisement on the client computing device.

According to an aspect of the combined systems, said advertising software further comprises a mailbox adapted for receiving and displaying electronic advertisement brochures. The advertisement software comprising such mailbox may result in the user being provided with more choices for displaying advertisements, and may result in advertisers being more prone to using the system according to the invention.

According to an aspect of the combined systems, at least one still image advertisements is downloaded and subsequently displayed during the download of at least one moving image advertisement to be displayed. Downloading moving image advertisements may take more time than downloading still image advertisements. By displaying still image advertisements during download of moving image advertisements, the result may be that the user will not experience, or at least the user will experience only very little, delay between choosing to display moving image advertisements and the moving image advertisements being displayed.

According to an aspect of the combined systems, none of the still image advertisements are displayed until all the still image advertisements have been downloaded. With such an embodiment, the result may be that the display duration of still image advertisements is equal for each still image advertisement.

According to an aspect of the combined systems, said advertising software displays said multimedia files as image advertisements on the screen in a temporal sequence, the displaying of the next image advertisement being contingent to user input action within a certain time limit after the preceding image advertisement is finished. With such an embodiment, the result may be that the advertising software allows registering that the user has actually viewed the advertisement.

According to an aspect of the combined systems, the system has means for allowing only a predetermined number of image advertisements to be displayed within a given time period. With such an embodiment, the result may be that the advertising software allows to limit the duration of display of the advertisement and to increase the variety of the advertisement offered to display in order to make sure that the user watches the advertisement.

According to an aspect of the combined systems, said software comprises control means for confirming that the user has viewed the image advertisement. With such an embodiment, the result may be that the advertising software registers that the user has actually viewed the advertisement.

According to an aspect of the combined systems, said control means comprises at least one user feedback element displayed on the visual output and to be activated by the user within a certain time limit after the display of the image advertisement is finished to confirm the user's viewing of the image advertisement; and

means for pseudo-randomly placing the at least one user feedback element on the visual output at the end of the display of an image advertisement. With such an embodiment, the result may be that the advertising software counterstrikes malicious users that try to cheat the advertising system.

According to an aspect of the combined systems, said advertising software comprises means for offering to redirect the user to a website corresponding to the at least one viewed image advertisement. With such an embodiment, the result may be that the advertising software offers a better provisioning of the service for the user to access websites related to the advertisement viewed. This way, the user does not have spend time looking for the website related to the specific advertisement viewed.

According to an aspect of the combined systems, said advertising software comprises means for registering information about the display of said image advertisements, including confirmation of the user's viewing of said image advertisements, means for communicating said information to a server, said server comprising means for effecting remuneration of a person identified as the user of the software. With such an embodiment, the result may be that the advertising software allows to register information of the user's viewing and to increase the number of advertisement views.

According to an aspect of the combined systems, said advertising software comprises means for allowing the user to convert the remuneration into at least one of the following financial contributions: a service offered by a service provider to the user, a donation offered by the user to others. With such an embodiment, the result may be that the advertising software allows the user to choose different types of remuneration.

According to an aspect of the combined systems, the computing device is selected from the group of a personal computer, a gaming console, a personal digital assistant, a cellular phone. With such an embodiment, the result may be the portability of the invention to several platforms.

In a further aspect, the combined systems provide a method of advertising based on user-relevant categories of advertisements, said method comprising: obtaining information about user-relevant categories of advertisements, downloading at least one multimedia file comprising at least one image advertisement in accordance with said user-relevant categories,

detecting a triggering event initiated by the user activating a user input interface of the client computing device,
upon detection of the triggering event, allowing the user to choose whether or not to display the at least one image advertisement downloaded, displaying on visual output the at least one of image advertisement if the user has chosen the at least one image advertisement to be displayed,
temporarily blocking access to content on a communication network as long as the at least one image advertisement is displayed.

According to an aspect of the combined systems, a starting said browser on the computing device triggers the event to be detected for allowing the user to choose whether or not to display the at least one image advertisement ready to be displayed. The triggering event for at least allowing the user whether to display the advertisement or not may result in the advertisements often being displayed, considering that starting a browser on a computing device is an event that happens often on a computing device.

According to an aspect of the combined systems, access to said browser is blocked, when the triggering event is detected. Thereby, the user is prompted to choose to display the advertisement on the computing device.

According to an aspect of the combined systems, downloading a number of still image advertisements is performed during the download of the first moving image advertisement and then subsequently displaying of the downloaded still image advertisements is performed. By displaying still image advertisements during download of moving image advertisements, the result may be that the user will not experience, or at least the user will experience only very little delay between choosing to display moving image advertisements and the moving image advertisements being displayed.

According to an aspect of the combined systems, displaying of the still image advertisements is not performed until all the still image advertisements have been downloaded. With such an embodiment, the result may be that the display duration of still image advertisements is equal for each still image advertisement.

According to an aspect of the combined systems, displaying said multimedia files as image advertisements is performed in a temporal sequence, the displaying of the next image advertisement being contingent to user input action within a certain time limit after the preceding image advertisement is finished. Such an embodiment results in registering that the user has actually viewed the advertisement.

According to an aspect of the combined systems, displaying a predetermined number of image advertisements only is performed within a given time period.

Such an embodiment may result in limiting the duration of display of the advertisement and increasing the variety of the advertisement offered to display in order to make sure that the user watches the advertisement.

According to an aspect of the combined systems, confirming that the user has viewed the image advertisement is performed. Such an embodiment may result in the possibility of registering that the user has actually viewed the advertisement.

According to an aspect of the combined systems, the combined systems are capable of placing pseudo-randomly at least one user feedback on the visual output, and the user activates the at least one user feedback element, at the end of the display of an image advertisement within a certain time limit after the display of the image advertisement is finished, with said feedback element registering the user's viewing of the image advertisement. Such an embodiment may result in counterstriking malicious users that try to cheat the advertising system.

According to an aspect of the combined systems, the combined systems are capable of redirecting the user to a website corresponding to the at least one viewed image advertisement. Such an embodiment may result in a better provisioning of the service for the user to access websites related to the advertisement viewed. This way, the user does not have spend time looking for the website related to the specific advertisement viewed.

According to an aspect of the combined systems, the combined systems are capable of registering information about the display of said image advertisements, said information including confirmation of the user's viewing of said image advertisements, and wherein said information is communicated to a server, said server effecting remuneration for viewing the advertisements of a person identified as the user of the software. Such an embodiment may result in monitoring the user's views and increasing the number of advertisement views.

According to an aspect of the combined systems, the combined systems are capable of converting the remuneration into at least one of the following financial contributions: a service offered by a service provider to the user, a donation offered by the user to others. Such an embodiment may result in allowing the user to choose different types of remuneration.

In a further aspect of the combined systems, the invention provides a system for advertisers to display advertisements on a visual output of a client computing device to a user of the client computing device, said system comprising: the client computing device having network connectivity and at least one display for visual output from the computing device,

a browser software constituting part of said system and adapted to run on said client computing device for accessing content on a communication network,
a server device having network connectivity and accessible from a communication network,
an advertiser software constituting part of said system and adapted to run on said server device,
said advertiser software allowing an advertiser to upload at least one multimedia file comprising image advertisements,
said advertiser software allowing an advertiser to indicate at least one category of the uploaded image advertisement,
said advertiser software allowing an advertiser to select demographics and location information of targeted viewers,
said advertiser software allowing an advertiser to enter a timing for uploaded advertisement to be distributed to targeted viewers, and
said advertiser software providing an advertiser with statistical information related to viewers of the uploaded image advertisement. With such an embodiment, the result may be providing advertisers with a system to monitor configure and control their advertising campaigns in real-time.

According to an aspect of the combined systems, the demographics of targeted viewers comprise age, age range, gender, personal status, financial capability, and profession. With such an embodiment, the result may be that the advertiser system allows to configure an advertising campaign and to implement the configuration adjustments in real-time with almost no time delay.

According to an aspect of the combined systems, the location information of targeted viewers comprises country, region, and postal code. With such an embodiment, the result may be that the advertiser system allows to configure an advertising campaign and to implement the configuration adjustments in real-time with almost no time delay.

According to an aspect of the combined systems, the timing for uploaded advertisement to be distributed to targeted viewers is a lifetime period, a priority of distribution over the said period, a distribution frequency per time unit of the said period and any combination thereof. With such an embodiment, the result may be that the advertiser system allows to configure an advertising campaign and to implement the configuration and adjustments in real-time with almost no time delay.

According to an aspect of the combined systems, the statistical information related to viewers of the uploaded image advertisement comprises number of views, number of viewer clicks, a metric relating the number of views to the number of clicks, and geographical information of the viewers. With such an embodiment, the result may be that the advertiser system allows to monitor an advertising campaign in real-time.

This aspect of the invention is particularly, but not exclusively, advantageous in that the present invention may be accomplished by a computer program enabling a computer to carry out the operations of the system of the invention when down-or uploaded into the computer system. Such a computer program may be provided on any kind of computer readable medium, or through a network.

The individual aspects of the present invention may each be combined with any of the other aspects. These and other aspects of the invention will be apparent from the following description with reference to the described embodiments.

### BRIEF DESCRIPTION OF THE FIGURES

The system and method according to the invention will now be described in more detail with regard to the accompanying figures. The figures show one way of implementing the present invention and is not to be construed as being limiting to other possible embodiments falling within the scope of the attached claim set.

FIG. 1 shows elements comprised in the systems for publishing and distributing a media file to a client over a communication network,

FIG. 2 is a schematic system-chart representing an alternative out-line of the operations of the system for the publishing of a media file according to the invention,

FIG. 3 is a schematic system-chart representing an alternative outline of the operations of the system for distribution of a media file according to the invention.

FIG. 4 is a schematic system-chart representing a preferred outline of the operations of the system for publishing of a media file according to the invention,

FIG. 5 is a schematic system-chart representing a preferred outline of the operations of the system for distribution of a media file according to the invention.

### DETAILED DESCRIPTION OF AN EMBODIMENT

In accordance with the invention there is provided a system for distributing a media file to a requester over a communication network and a system for publishing a media file onto a system comprising a plurality of servers.

As used herein, the term “client” refers to a computing device or computer comprising an application or a system that accesses remotely a service on another computer system, known and referred herein to as a “server”, via a communication network.

As used herein, the term “requester” refers to a client computing device adapted to send a request for a media file over a communication network and to receive information associated with the media file and the media file. The server is adapted to receive requests and reply to requests. The server can be part in a cluster of servers to guarantee reliability and availability of the system.

In the present application, the terms requester and client may be equivalent.

As used herein, the term “media file” refers to a file comprising at least one type of media and/or one type of media content. The media file may comprise a plurality of media, or a plurality of media files, or a plurality of multimedia files or a combination thereof. The media may also be a executable file in that it causes a computer to perform indicated tasks according to encoded instructions.

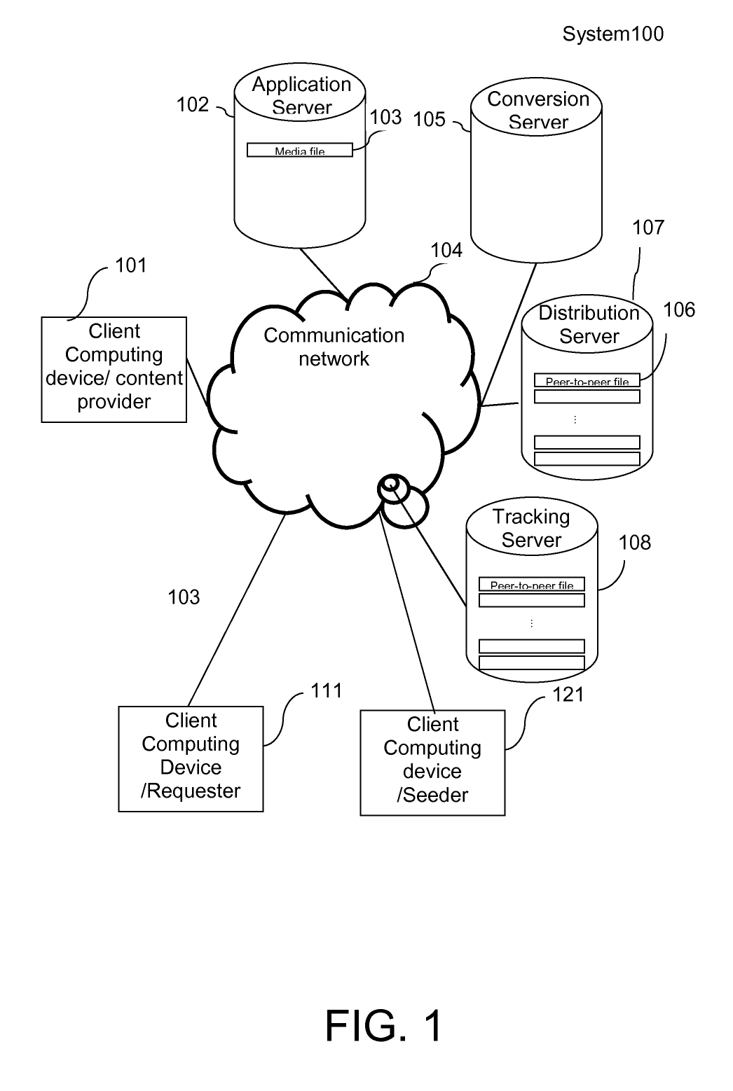

FIG. 1 shows the architecture 100 illustrating elements comprised in the systems for publishing and distributing a media file to a client over a communication network: three client computing devices (101 of a content provider, a client requester 111, a client seeder 121), an application server 102, a conversion server 105, a distribution server 107, a tracking server 108 and a communication network 104.

A conversion server is a server that converts the received media file into a peer-to-peer file.

The peer-to-peer file may be a plurality of files such as video file and pdf file.

In an embodiment of the system, the distribution server works together with a storage area network or database where the actual peer-to-peer files are stored. A storage area network (SAN) is an architecture to attach remote computer storage devices (such as disk arrays, tape libraries, and optical jukeboxes) to servers in such a way that the devices appear as locally attached to the operating system. The distribution server of this embodiment stores a pointer that links to the actual location of the peer-to-peer file in the SAN.

In one embodiment of the system, the distribution server stores in the peer-to-peer files in a collocated memory.

The distribution server acts a super-seeder that always has a copy of the peer-to-peer file constituting the media file distributed. The distribution server acting as a super-sedder improves for example availability and reliability of a peer-to-peer file distribution system because if the requester peer-to-peer file cannot be found at any seeder, then the super-seeder can serve the requester.

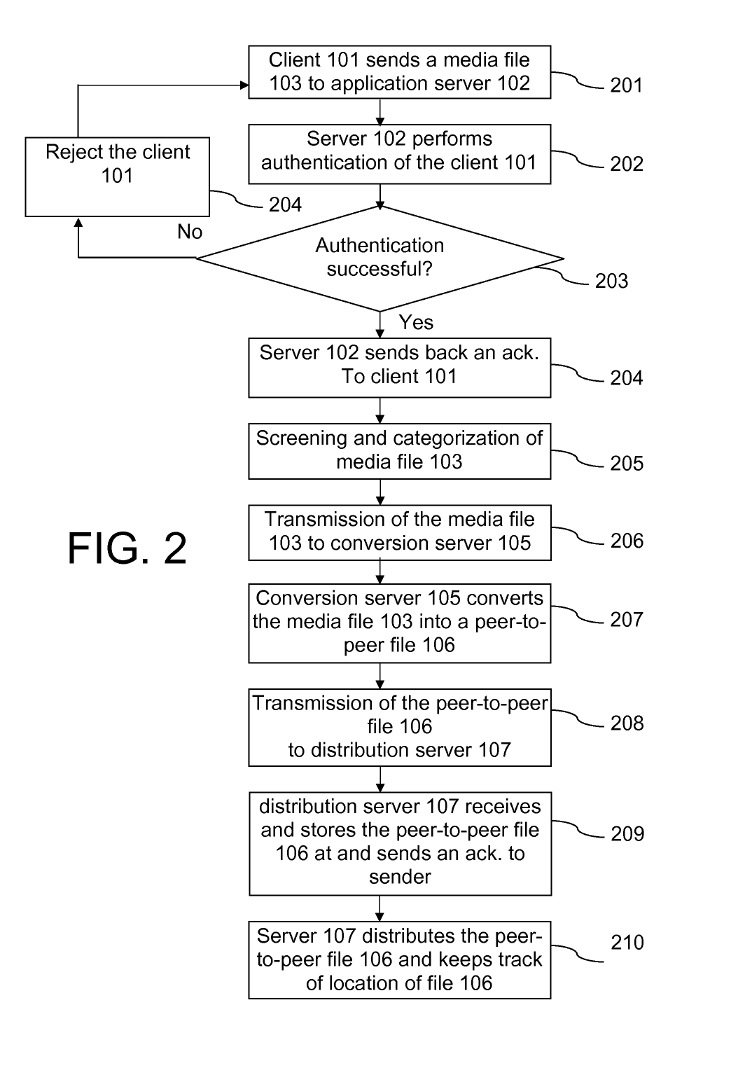

FIG. 2 is a schematic system-chart representing an alternative out-line of the operations of the system for the publishing of a media file.

In step 201, the client computing device 101 sends or uploads the media file 103 to the application server 102 over the communication network 104. Upon receiving the media file 103, the application server 102 authenticates the client 101 in steps 202 and 203.

In step 204 the application server 102 sends back to the client 101 an acknowledgement to confirm the reception of the media file 103 provided that the client has been authenticated successfully.

In step 205, the media file 103 is then screened and categorized in order to be later processed with regard to censorship (i.e. to avoid censorship violation when being transmitted to a viewer). The screening and categorization may be performed on the application server 102 or may be performed on another entity and/or by a moderator.

After being screened, the media file 103 is sent to a conversion server 105 in step 206. In step 207, the conversion server 105 converts the media file 103 into a peer-to-peer file or file package 106 that is integrity-protected, fragmentable, encapsulated in a specific header and has a unique correspondence to the media file 103.

Once the conversion performed, at step 208 the conversion server 105 sends the peer-to-peer file 106 corresponding to the media file 103 to one or a plurality of distribution server 107-108, possibly via the application server 102. Whether the peer-to-peer file 106 is sent via the application server 102 or directly to one or a plurality of distribution servers 107 depends on the implementation of the system.

The distribution server 107 performs the distribution of the file 106 while the tracking server 108 finds the location of the file 106 in the architecture (i.e. acting as a tracker for peer-to-peer files). The distribution servers 107 can be collocated with the tracking server 108. Or the distribution servers 107 can be dedicated to distributing peer-to-peer files (the latter is called a “super-seeder”).

The application server 102, the conversion server 105 and the distribution server 107 could also be co-located within the same hardware, and the transmission of the peer-to-peer file 106 would take place in form of a communication between two processes. The selection of the destinations where the peer-to-peer file 106 is to be sent by the conversion server or application server is based on a set of criteria, being at least the category of the media file 103 and the geographic location of the distribution servers to avoid violations related to the law of a territory.

At step 209, the distribution server 107 receiving the peer-to-peer file 106 stores the peer-to-peer file 106 in its memory and acknowledges the reception of the file 106.

At step 210, the distribution servers storing file 106 can then distribute it to other distribution servers and seeking clients and keeps track, possibly together with the tracking server 108, of the location information and status of the servers and hosts to which the file 106 has been given.

In one embodiment of the system, the conversion server creates an ad file package and then uploads the file to at least one of the distribution servers (also called super seeder). The conversion server creates a file which contains the following information:
The tracking server's IP\Ports that are associated with the ad file package,
A hash code that uniquely identifies the package for example according to its contents, the size of its logical blocks,
Checksums of each and every logical block within the package for error detection and correction.

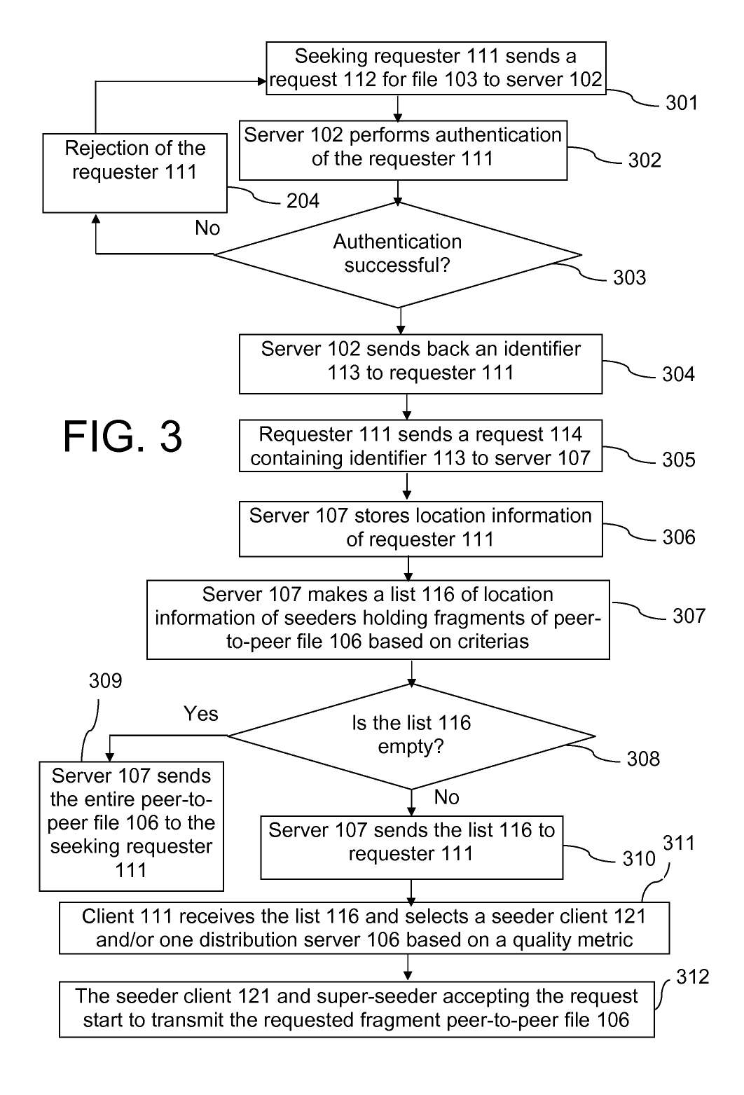

FIG. 3 is a schematic system-chart representing an alternative outline of the operations of the system for distribution of a media file.

In step 301, a client computing device or requester 111 seeks a media file 103 and therefore sends a request 112 for a media file 103 over the communication network 104 to a remote server, which is preferably an application server 102. Upon reception of a request 112, at step 302-303 the application server authenticates the seeking requester 111.

At step 304 the application server 102 sends back to the client/requester 111 an identifier 113 associated with the media file 103 requested provided that the seeking requester has been authenticated successfully. At step 305, the authenticated client requester 111 receives the identifier 113 and sends to the distribution server 107 a request 114 containing the identifier 113.

At step 306, the distribution server 107 receiving the request 114 stores location information (e.g. IP address) of the client requester 111. The distribution server with tracking server holds a list 115 comprising location information of one or more clients 121 that have sent requests containing the same identifier 113 before the seeking requester 111 sent the request 114, as well as location information of distribution servers that act as super seeders This allows the distribution server 107 to act as a tracker for peer-to-peer files.

Clients 121 having requested the same peer-to-peer file 106 with the same identifier 113 corresponding to the same media file 103 have most likely managed to obtain the same file 106 and therefore may still have at least fragments of the file 106 stored in their memory. Clients 121 are therefore able to provide the seeking client requester 111 with fragments of the file 106.

Clients 121 are referred to herein as “leechers” or “seeders”. The distribution server with the tracking server or the tracking server updates the list 115 at each seeking client request and upon status update received from seeders and super-seeders.

At step 307, the distribution server 107 makes a list 116 by selecting location information of seeders and super-seeders based on:
Actual availability of the requested file 106 at the seeder or super-seeder,
censorship associated with the media file and with the location of the seeder or super-seeder holding at least of one fragment of the peer-to-peer file 106,
at least one metric characterizing a resource of the seeder or super-seeder.

At step 308, the distribution server 107 checks whether the list 116 is empty or not. If the list 116 is empty, the distribution server 107 proceeds to step 309 and sends the entire peer-to-peer file 106 corresponding to the media file matching the identifier to the seeking client requester 111.

If the list 116 is not empty, the distribution server 107 proceeds to step 310 and sends the list 116 comprising location information of one or more seeder clients 121 and one or more super-seeders 107. The seeking requester 111 receives the response comprising the list 116 associated with the requested file 103 and selects at least one seeder client and/or one super seeder to be requested based on at least one metric characterizing a quality of a communication link (e.g. delay, throughput, number of hops) between the seeking requester 111 and the seeder client or super-seeder holding at least one of the desired fragment of the peer-to-peer file 106.

In step 311, the seeking requester 111 sends one or more requests to the one or more selected seeder clients and super-seeders in order to obtain the desired one or more fragments of the peer-to-peer file 106. In step 312, the selected seeder clients and super-seeders accepting the request start to transmit the requested fragment peer-to-peer file 106.

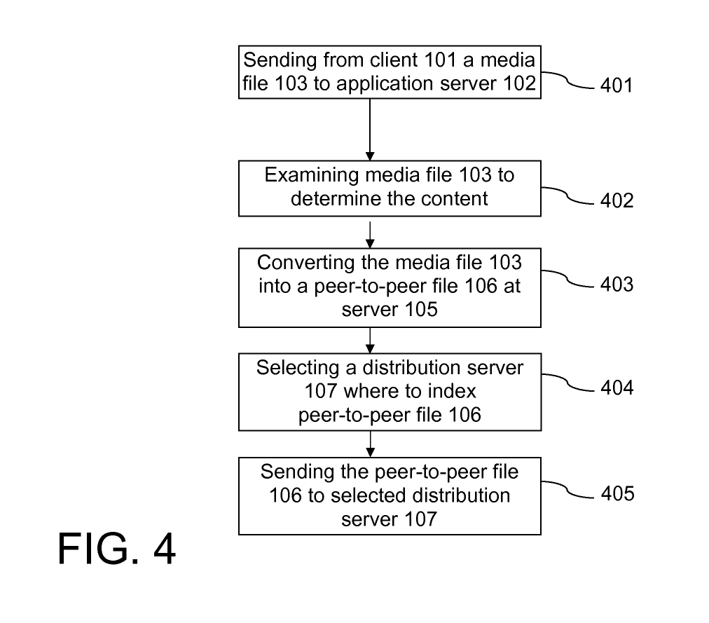

FIG. 4 is a schematic system-chart representing a preferred outline of the operations of the system for publishing of a media file.

In step 401, the client computing device 101 sends or uploads the media file 103 to the application server 102 over a communication network 104.

In step 402, the publishing system examines the media file to determine a content of the media file, for example to screen and categorize the media file so that later it can be processed with regard to censorship (i.e. to avoid censorship violation when being transmitted to a viewer).

In step 403, the publishing system converts the media file into the peer-to-peer file 106. In step 404, the publishing system selects a distribution server in the publishing system where the peer-to-peer file is to be indexed, based on a plurality of criteria, said criteria being at least a criteria within the following categories: a content of the media file, a geographic location of a recipient of the peer-to-peer file, a set of law of the geographic location, or a load balancing.

In Step 405, the peer-to-peer file 106 is sent to the selected distribution server 107 for indexation. The peer-to-peer file's location at the selected distribution server 107 is recorded that the tracking server 108 to keep track of the peer-to-peer file.

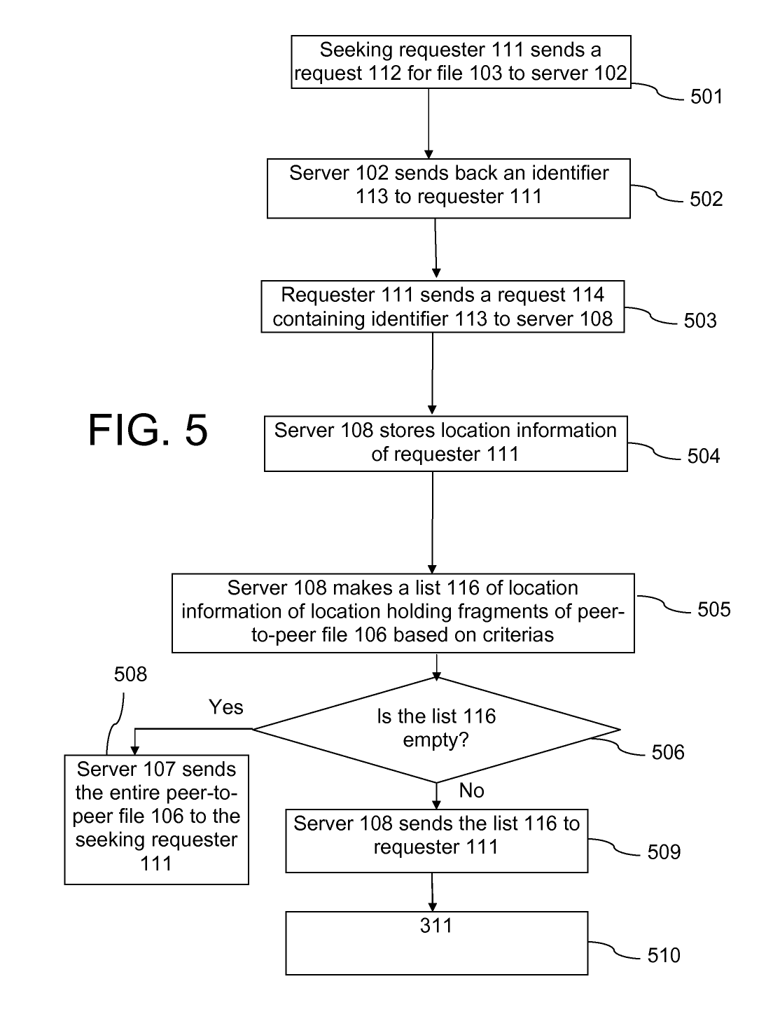

FIG. 5 is a schematic system-chart representing a preferred outline of the operations of the system for distribution of a media file.

In step 501, a client computing device or requester 111 seeks a media file 103 and therefore sends a request 112 for a media file 103 over the communication network 104 to a remote server part of the system for distributing a media file, which is preferably an application server 102.

At step 502 the application server 102 sends back to the client/requester 111 an identifier 113 associated with the media file 103 requested.

At step 503, the client requester 111 receives the identifier 113 and sends to the tracking server 108 a request 114 containing the identifier 113.

At step 504, the tracking server 108 receiving the request 114 stores a location information (e.g. IP address) of the client requester 111.

At step 505, the tracking server 108 makes a list 116 by selecting location information of seeders (i.e. client 121) and super-seeders (i.e. distribution servers 107) based on:
Actual availability of the requested file 106 at the seeder or super-seeder,
censorship associated with the media file and with the location of the seeder or super-seeder holding at least of one fragment of the peer-to-peer file 106,
at least one metric characterizing a resource of the seeder or super-seeder.

At step 506, the tracking server 108 determines whether the list 116 is empty or not. If the list 116 is empty, the tracking server 108 proceeds to step 508 and request the sending the entire peer-to-peer file 106 corresponding to the media file matching the identifier to the seeking client requester 111. The sending may originate from one of the first distribution servers receiving a copy of the peer-to-peer file 106 from the publishing process or the SAN coupled with the first distribution servers

If the list 116 is not empty, the tracking server 108 proceeds to step 509 and sends the list 116 comprising location information of one or more seeder clients 121 and one or more super-seeders 107. The seeking requester 111 proceeds to step 311 of FIG. 3: the requester receives the response comprising the list 116 associated with the requested file 103 and selects at least one seeder client and/or one super seeder to be requested based on at least one metric characterizing a quality of a communication link (e.g. delay, throughput, number of hops) between the seeking requester 111 and the seeder client or super-seeder holding at least one of the desired fragment of the peer-to-peer file 106.

Then, the seeking requester 111 sends one or more requests to the one or more selected seeder clients and super-seeders in order to obtain the desired one or more fragments of the peer-to-peer file 106. Finally, the selected seeder clients and super-seeders accepting the request start to transmit the requested fragment peer-to-peer file 106.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality.

The possible use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A system for publishing a media file, the system comprising:
a) a client computing device of a content provider, said client computing device having connectivity with a communication network and being adapted to send the media file over the communication network;
b) at least one application server adapted to:
i) receive the media file,
ii) examine the media file to determine a content of the media file,
iii) send the media file, and
iv) send a peer-to-peer file corresponding to the media file,
c) at least one conversion server adapted to:
i) receive the media file,
ii) convert the media file into the peer-to-peer file, and
ii) send the peer-to-peer file,
d) at least one distribution server adapted to:
i) receive the peer-to-peer file; wherein
e) said system is adapted to:
i) select, based on a plurality of criteria, said at least one distribution server where the peer-to-peer file is to be indexed, said criteria being at least a criteria within the following categories: a content of the media file, a geographic location of a recipient of the peer-to-peer file, a set of law of the geographic location, a load balancing; and
ii) send, to the selected distribution server, the peer-to-peer file for the peer-to-peer file to be indexed at the selected distribution server.

2-22. (canceled)

23. The system according to claim 1, wherein the media file comprises at least one of the following: a plurality of media, a plurality of files each with media, or a plurality of files each with multimedia, or a combination thereof.

24. The system according to claim 1, wherein the media file is an advertisement to be published on a computing device remote from the distribution server.

25. The system according to claim 1, wherein the peer-to-peer file is an electronic data package comprising a plurality of files.

26. The system according to claim 1, wherein the peer-to-peer file has at least one of the following characteristics: integrity-protected, fragmentable, or encapsulated in a header, or a combination thereof.

27. The system according to claim 1, wherein the at least one distribution server is adapted to distribute the peer-to-peer file to at least one other distribution server.

28. The system according to claim 1, wherein the application server is adapted to initially authenticate a client sending a request and to subsequently send an acknowledgement associated with the media file to the client, provided that the client initially has been authenticated by the application server.

29. A system for distributing a media file to a requester over a communication network, the media file being uploaded by a content provider, the system comprising:
a) the requester being a client computing device having connectivity to a communication network, said requester adapted to:
i) send a request for the media file over a communication network, and
ii) receive a response, the response being related to a peer-to-peer file associated with the requested media file;
b) at least one application server adapted to:
i) receive a request for the media file from the requester, and
ii) send to the requester an identifier associated with the media file;
c) at least one seeder computing device having connectivity to a communication network, said seeder computing device adapted to:
i) receive from a requester a request for at least a fragment of the peer-to-peer file, and
ii) send to the requester at least the fragment of the peer-to-peer file;
d) at least one distribution server adapted to:
i) receive the peer-to-peer file,
ii) receive a request for the peer-to-peer file, and
iii) request the sending of the peer-to-peer file;
e) at least one tracking server adapted to:
i) receive from the requester a request containing the identifier associated with the peer-to-peer file,
ii) store at the tracking server a location information corresponding to the requester,
iii) either send, to the requester, a list of at least one location information of at least one seeder having requested the peer-to-peer file prior to the requester and a location information of at least one distribution server able to request the sending of the peer-to-peer file or
iv) with the proviso that the tracking server has no location information stored of at least one seeder or of at least one distribution server having the peer-to-peer file, send, to the requester, the peer-to-peer file corresponding to the identifier;
f) said system comprising:
i) the tracking server adapted to provide a list of at least one location information of at least the fragment of the peer-to-peer file at the at least one seeder or at the at least one distribution server, based on at least one of the following criteria:
availability, at the at least one seeder computing device, of at least the fragment of the peer-to-peer file corresponding to the identifier,
a content of the media file, a geographic location of a recipient of the peer-to-peer file, or a set of law of the geographic location, and
ii) the requester adapted to select at least one seeder to be requested among the plurality of the at least one seeder, based on at least one criteria characterizing a quality of a communication link between the requester and the at least one seeder.

30. The system according to claim 29, wherein the at least one distribution server and the at least one tracking server are collocated in a same unit within the communication network.

31. The system according to claim 29, wherein the media file comprises at least one of the following: a plurality of media, a plurality of files each with media, or a plurality of files each with multimedia, or a combination thereof.

32. The system according to claim 29, wherein the media file is an advertisement to be published on a computing device remote from the distribution server.

33. The system according to claim 29, wherein the requester is a leecher.

34. The system according to claim 29, wherein the application server is adapted to initially authenticate a client having sent a request to the application server, and wherein the application server is adapted to subsequently send an identifier associated with the peer-to-peer file to the client, provided the client initially has been authenticated by the application server.

35. The system according to claim 29, wherein the client requesting the media file is a client authenticated by a server of the system, and wherein the seeder is a seeder authenticated by a server of the system.

36. A system according to claim 35, wherein the client is a leecher.

37. A method for distributing a media file to a requester over a communication network, the media file being uploaded by a content provider, the method comprising:
a) sending a request for the media file over a communication network from the requester to an application server;
b) receiving a request for the media file from the requester at the application server,
c) sending to the requester an identifier associated with a peer-to-peer file corresponding to the media file;
d) sending a request for the peer-to-peer file to a distribution system, the request containing at least the identifier;
e) receiving at a tracking server of the distribution system the request for the peer-to-peer file from the requester;
f) storing at the tracking server a geographical location information corresponding to the requester;
g) sending to the requester a list of at least one geographical location information of at least one seeder having requested the peer-to-peer file prior to the requester and a geographical location information of at least one distribution server able to request the sending of the peer-to-peer file, the list of at least one location information being based on at least one of the following criteria:
i) availability of at least the fragment of the peer-to-peer file corresponding to the identifier at the at least one seeder, or
ii) a content of the media file, a geographic location of a recipient of the peer-to-peer file, or a set of law of the geographic location;
h) receiving, at the requester, the list of the at least one location information of at the at least one seeder computing device or distribution server capable of sending at least the fragment of the peer-to-peer file;
i) determining, in the list received at the requester, a seeder to which a request for at least the fragment of the peer-to-peer file is to be sent, based on at least one criteria characterizing a quality of a communication link between the requester and the at least one seeder;
j) sending, from the requester to each determined seeder, a request for a fragment of the peer-to-peer file;
k) receiving, at the seeder, the request for at least the fragment of the peer-to-peer file;
l) sending, from the seeder to the requester, at least the requested fragment of the peer-to-peer file; and
m) receiving, from the seeder at the requester, at least the requested fragment of the peer-to-peer file requested.

38. A computer program product embodied in a computer-readable medium, said computer-readable medium capable of being read by a computer system for performing the method in accordance with claim 37.

39. An apparatus of a requester, said apparatus having computing capabilities and having connectivity to a communication network, said apparatus adapted to:
a) send, to a seeder, a request for a media file over the communication network,
b) send, to a seeder, a request for a peer-to-peer file associated with the requested media file, and
c) receive a response, the response being related to the peer-to-peer file associated with the requested media file.

40. An apparatus of a seeder, said apparatus having computing capabilities and having connectivity to a communication network, said apparatus adapted to
a) receive, from a requester, a request for at least a fragment of a peer-to-peer file, and
b) send, to the requester, at least the fragment of the peer-to-peer file requested.

41. A method for publishing a media file, the method comprising:
a) sending the media file over the communication network from a client computing device of a content provider;
b) receiving the media file at an application server of a publishing system;
c) examining in the publishing system the media file to determine a content of the media file,
d) converting in the publishing system the media file into a peer-to-peer file,
e) selecting a distribution server in the publishing system where the peer-to-peer file is to be indexed, based on a plurality of criteria, said plurality of criteria comprising at least a criteria within the following categories: a content of the media file, a geographic location of a recipient of the peer-to-peer file, a set of law of the geographic location, or a load balancing; and
f) sending to the selected distribution server the peer-to-peer file for indexing the peer-to-peer file at the selected distribution server.

42. The method according to claim 41, wherein the application server initially authenticates the client having sent a request to the application server, and wherein the application server subsequently sends an identifier associated with the media file to the client, provided that the client initially has been authenticated by the application server.

43. The method according to claim 41, wherein the client requesting the media file is a client being authenticated by a server of the system, and wherein the seeder is a seeder being authenticated by a server of the system.
